(19) United States
(12) Patent Application Publication
(10) Pub. No.: US 2011/0195165 A1
(43) Pub. Date: Aug. 11, 2011

(54) Material and sheet for packaging bacon and/or other meats, and methods for making and using the same

(76) Inventor: John E. Cahill, Wellington, FL (US)

(21) Appl. No.: 12/658,386

(22) Filed: Feb. 8, 2010

(51) Int. Cl. B65B 25/06; B65D 75/00; B29C 44/42

(52) U.S. Cl. 426/415; 229/87.11; 264/53

(57) ABSTRACT

A packaging sheet, which can also be used for packaging other meats, includes a polymer having a microstructure that includes a plurality of closed cells, each cell containing a void and each cell having a maximum dimension extending across the void within the cell that ranges between 1 micrometer and 200 micrometers long. When used to package bacon, the packaging sheet may also include a main portion, a flap pivotable relative to the main portion, a first surface that extends across the main portion and the flap, and that contacts the bacon, a second surface that extends across the main portion and the flap, and that does not contact the bacon, and a thickness that extends from the first surface to the second surface in a direction perpendicular to the first surface.

### BACKGROUND

Moist or greasy food such as bacon and other meats are typically packaged for transportation and display by partially wrapping the bacon or other meat with a semi-rigid sheet commonly referred to as a backing board or bacon board, and then vacuum sealing the bacon or other meat and the semi-rigid sheet inside a transparent plastic wrapper. The backing board holds the slices of bacon or meat together as the bacon and meat proceed through the packaging process and machinery.

Backing boards are typically made of either plant fiber, such as paper or cardboard, or a laminated composite plastic film. Unfortunately, however, both types of materials can cause problems when used to make a backing board.

When paper or cardboard is used to make a backing board, the paper or cardboard can absorb moisture and/or grease from the bacon or other meat. This can cause the sheet to lose its semi-rigid property and become limp or too flexible to adequately hold the bacon or other meat during the packaging process. Absorbing moisture and/or grease can also introduce unwanted microorganisms such as mold and bacteria to the moisture and/or grease which can cause the bacon and/or meat to spoil prematurely and/or loose its visual appeal to a consumer.

In response to this problem, many laminate the paper or cardboard with a plastic film and/or coat the paper or cardboard with a wax coating and then force some of the wax into the paper or cardboard to prevent absorption. Unfortunately, this adds material to the backing board, and a step to the board's manufacturing process, both of which increase the manufacturing cost of the board. Moreover, the laminate and/or coating process often fails to adequately seal the edge of the board, causing the moisture or grease to wick into the paper or cardboard core.

When a laminated composite plastic film is used to make a backing board, the laminate film can be more expensive to manufacture than the paper or cardboard based boards and can also absorb moisture and/or grease from the bacon or other meat. Typically, such laminated composite plastic film includes a core having an open-cell microstructure and two or more covering plies that have a solid microstructure. Thus, the manufacturing steps of foaming the core, and then fixing the covering plies to the core makes the backing board expensive to manufacture. Moreover, because the core has an open-cell microstructure, the edges of the board must be sealed to prevent any moisture and/or grease from wicking into the core and thus prevent the introduction of unwanted micro-organisms to the bacon or other meat.

### SUMMARY

In one aspect of the invention, a packaging sheet, which can be used for packaging bacon and other meats, includes a polymer having a microstructure that includes a plurality of closed cells, each closed cell containing a void and each closed cell having a maximum dimension extending across the void within the cell that ranges between 1 micrometer and 200 micrometers long. In an embodiment of the packaging sheet, the sheet also includes a main portion, a flap pivotable relative to the main portion, a first surface that extends across the main portion and the flap, and that contacts bacon and/or other meats when the sheet is used to package the bacon and/or other meats, a second surface that extends across the main portion and the flap, and that does not contact the bacon and/or other meats when the sheet is used to package the bacon and/or other meats, and a thickness that extends from the first surface to the second surface in a direction perpendicular to the first surface.

With a closed-cell microstructure, moisture or grease from bacon or other meats will not wick into the polymer. Thus, the bacon or other meats that are packaged with the bacon packaging sheet are more likely to not lose their visual appeal to consumers, and are less likely to spoil in their package. Furthermore, with the closed-cell structure, the bacon packaging sheet does not require additional, cost increasing, manufacturing steps to seal the sheet's core. In addition, the amount of polymer material consumed by each bacon packaging sheet is less than the amount of plastic consumed by conventional backing boards that include paper, cardboard, or conventional laminated composite plastic films, and thus costs less than conventional backing boards to manufacture.

In another aspect of the invention, a method for making a bacon packaging sheet, which can also be used for packaging other meats, includes generating a microstructure in a roll of a polymer film wherein the microstructure has a plurality of closed cells, each closed cell containing a void and each closed cell having a maximum dimension extending across the void within the closed cell that ranges between 1 micrometer and 200 micrometers long. The microstructure can be generated by first dissolving into the polymer film, a gas that does not react with the polymer, and then making the whole polymer film or regions within the polymer film thermodynamically unstable at a temperature that is or close to the glass transition temperature for the polymer with the dissolved gas. Because the glass transition temperature for a polymer depends on whether or not gas is dissolved into the polymer, the glass transition temperature of the polymer with the dissolved gas is typically less than the glass transition temperature for the same polymer without dissolved gas. With the temperature at or near the glass transition temperature, bubbles of the gas can nucleate and grow in regions of the polymer that are thermodynamically unstable—i.e. supersaturated. Then, when the bubbles have grown to a desired size, the temperature of the polymer film is reduced below the glass transition temperature to stop the bubbles' growth.

### BRIEF DESCRIPTION OF THE FIGURES

FIG. 1 is a perspective view of a bacon packaging sheet, according to an embodiment of the invention.

FIG. 2 is a cross-sectional view of a portion of the bacon packaging sheet in FIG. 1, according to an embodiment of the invention.

FIG. 3 is a photograph of a cross-section of a portion of a polymer film having a closed-cell microstructure that can be used to make the bacon packaging sheet, according to an embodiment of the invention.

FIG. 4 shows a magnified portion of the photograph shown in FIG. 3.

FIG. 5 shows a magnified portion of the photograph shown in FIG. 4.

FIG. 6 is a schematic view of a process for generating a closed-cell microstructure in a polymer such as that shown in FIGS. 2-5, according to an embodiment of the invention.

### DETAILED DESCRIPTION

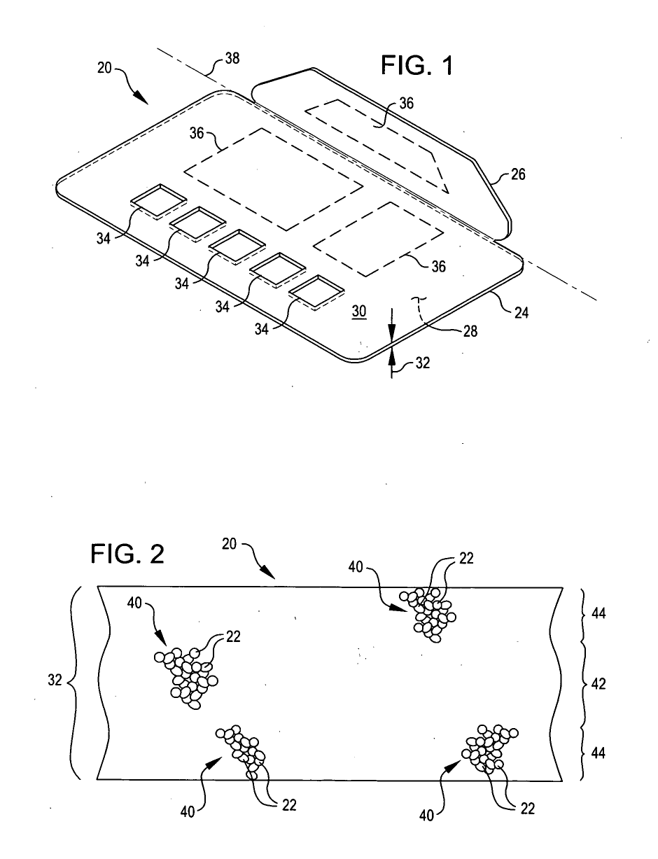

FIG. 1 is a perspective view of a bacon packaging sheet 20, according to an embodiment of the invention. The bacon packaging sheet 20 includes a polymer having a microstructure that includes a plurality of closed cells (not shown in FIG. 1 for clarity, but shown in FIGS. 2-5 and labeled with reference number 22). Although a bacon packaging sheet 20 is shown here, other packaging sheets, such as those used to package smoked fish, chicken and/or steaks, may also include the polymer. As further discussed in conjunction with FIGS. 2-5, each closed cell contains a void and each closed cell has a maximum dimension extending across the void within the cell that ranges between 1 micrometer (μm) and 200 μm long, inclusive. The bacon packaging sheet 20 also includes a skin (not shown for clarity, but shown and discussed in greater detail in conjunction with FIGS. 2, 3 and 6) that may be integral to the plurality of closed cells and/or other regions of the polymer's microstructure.

With the skin and closed-cell microstructure, moisture or grease from bacon or other meats will not wick into the polymer of the sheet 20, thus, preserving the visual appeal of the bacon or other meat to consumers when displayed in a grocery store. In addition, the bacon or other meats are less likely to spoil in their package. Another benefit of the closed-cell microstructure is that the bacon packaging sheet 20 does not require additional material, such as plies or laminates of solid plastic, to seal the microstructure from the environment outside of the microstructure. This is especially true if the sheet 20 includes the skin. Furthermore, because the microstructure includes closed cells and because the skin may be formed while the closed cell microstructure is formed, the bacon packaging sheet 20 does not require an additional manufacturing process, such as edge crimping, to seal the microstructure from the environment outside of the microstructure, and thus can be made by simply cutting, die cutting, or stamping a large film of the polymer that includes the microstructure (discussed in greater detail in conjunction with FIG. 6). Thus, the cost of manufacturing the bacon packaging sheet 20 is typically less than the cost of manufacturing conventional backing boards that include paper, cardboard, or conventional laminated composite plastic films.

The bacon packaging sheet 20 also includes a main portion 24, a flap 26 pivotable relative to the main portion 24, a first surface 28 that extends across the main portion 24 and the flap 26, and that contacts bacon and/or other meats (not shown in FIG. 1 for clarity) when the sheet 20 is used to package the bacon and/or other meats, a second surface 30 that extends across the main portion 24 and the flap 26, and that does not contact the bacon and/or other meats when the sheet 20 is used to package the bacon and/or other meats. In addition, the bacon packaging sheet 20 includes a thickness 32 that extends from the first surface 28 to the second surface 30 in a direction perpendicular to the first surface 28. The thickness may be any dimension desired and may be controlled by the process for generating the microstructure in a polymer film (discussed in greater detail in conjunction with FIG. 6) that the bacon packaging sheet 20 may be made from.

Still referring to FIG. 1, the bacon packaging sheet 20 may be configured as desired. For example, in this and certain other embodiments, the main portion 24 may be rectangular and dimensioned 5.5 inches by 10.1 inches, the flap 26 may be trapezoidal and dimensioned 2.4 inches by 9.6 inches by 7.5 inches, and the thickness may be 0.022 inches. The main portion 24 may include five windows 34 to allow one to see a region of the bacon or other meats after the bacon or other meats are packaged. The second surface 30 may included a region 36 (here three regions 36) that include text, graphics or both, to convey any desired information to a consumer. The text, graphics or both may be printed on the bacon packaging sheet 20 using any desired printing method such as flexography and gravure. The flap 26 may be pivotable about the axis 38, so that when bacon or other meats are placed on the first surface 28 of the main portion 24, the flap 26 may be wrapped around the edge of the bacon or other meats to hold the bacon or other meats during the completion of the packaging process.

Other bacon packaging sheet 20 configurations are possible. For example, the main portion may be oval and dimensioned other than 5.5 inches by 10.25 inches, the flap 26 may be rectangular and dimensioned other than 2.5 inches by 10.25 inches, and the sheet 20 may include more windows 34, fewer windows 34 or no windows 34.

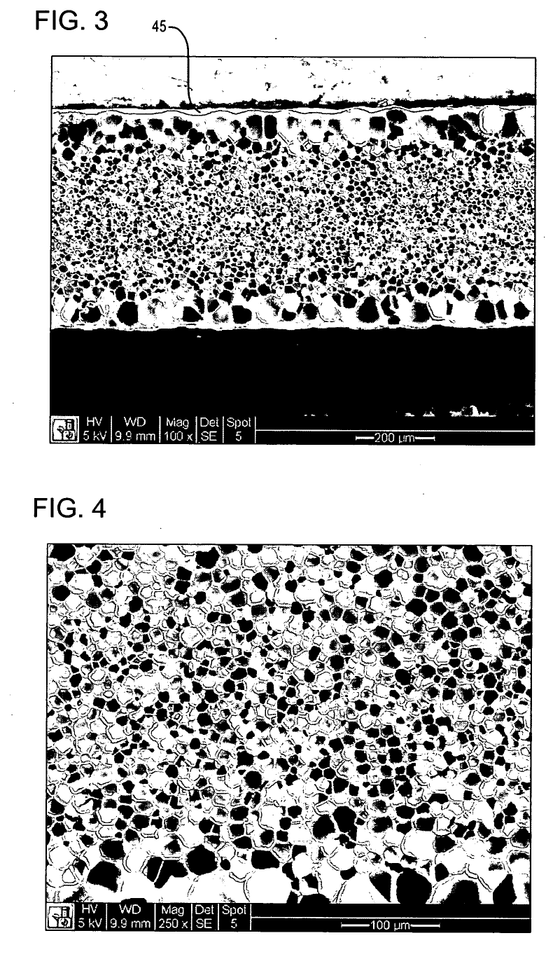

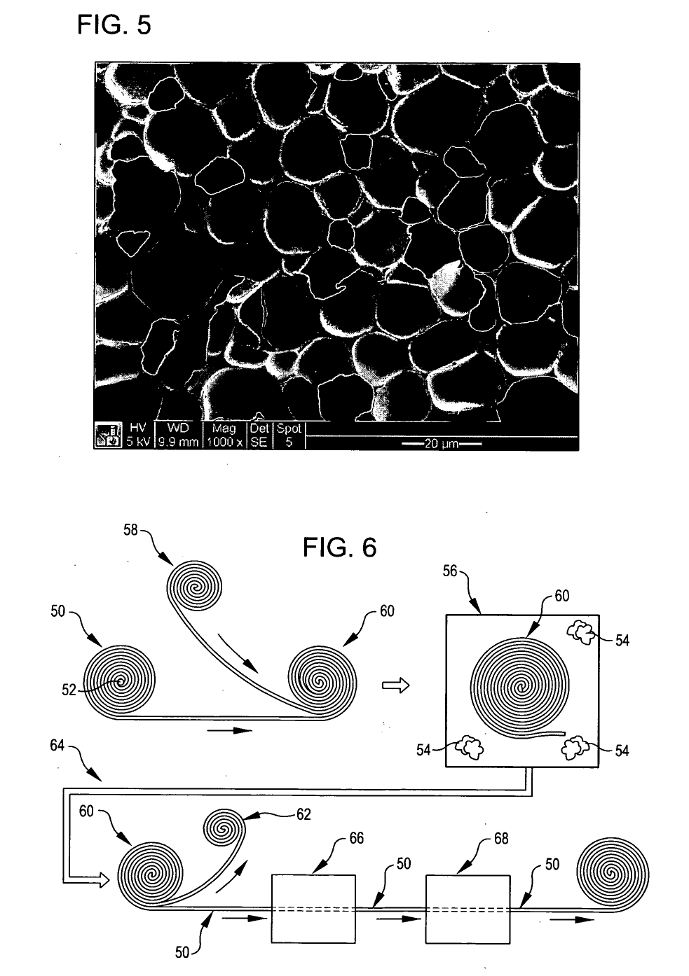

FIG. 2 is a cross-sectional view of a portion of the bacon packaging sheet 20 in FIG. 1, according to an embodiment of the invention. FIG. 3 is a photograph of a cross-section of a portion of a polymer film (discussed in greater detail in conjunction with FIG. 6) that has a closed-cell microstructure and a skin that can be used to make the bacon packaging sheet 20, according to an embodiment of the invention. FIG. 4 shows a magnified portion of the photograph shown in FIG. 3; and FIG. 5 shows a magnified portion of the photograph shown in FIG. 4.

The material composition of the polymer, the size of each closed cell 22, and the distribution of the closed cells 22 throughout the thickness 32 of the bacon packaging sheet 20 may be designed to provide the sheet 20 any desired mechanical properties, such as tensile strength, shear strength, and stiffness—i.e. resistance to bending. For example, the polymer may be any amorphous or semi-crystalline thermoplastic, the size of each closed cell may range between 1 and 200 μm long at its maximum dimension that extends across the void within the cell, and the closed cells may be uniformly dispersed throughout the thickness 32 of the sheet 20 (as shown in the photographs of FIGS. 3-5). Because the geometry of each closed-cell is rarely, if at all, a perfect sphere, the size of each closed cell is arbitrarily identified as the length of the longest chord that extends through the void within the closed cell. For example, the size of an oblong cell would be the length of the longest chord that extends in the same direction as the cell's elongation, and the size of a sphere would be the length of the sphere's diameter.

In this and certain other embodiments, the polymer includes polyethylene terephthalate (PET), the size of each closed cell 22 (only four clusters 40 of which are shown in FIG. 2 for clarity) ranges between 1 and 60 μm long, and the closed cells 22 are uniformly distributed throughout the thickness of the sheet. With this combination of material, closed-cell size, and closed-cell distribution in the thickness 32, the bacon packaging sheet 20 has adequate tensile strength, shear strength and stiffness for the sheet's thickness 32 to contain a conventional amount of bacon or other meat during the completion of their packaging process. Furthermore, the relative density of the bacon packaging sheet 20 is approximately 18.5%. The relative density is the density of the PET whose microstructure includes the closed cells 22, divided by, the density of the PET 32 whose microstructure does not include any of the closed cells 22—i.e. is solid. With this significant reduction in the relative density of the PET, the bacon packaging sheet 20 may contain much less material than conventional backing boards that include paper, cardboard, or conventional laminated composite plastic films.

To increase the bacon packaging sheet's tensile strength, shear strength, and/or imperviousness one can limit the distribution of the closed cells 22 to the middle region 42 of the thickness 32 (discussed in greater detail in conjunction with FIG. 6). By limiting the closed cells 22 to the middle region 42, the outer regions 44 may have a microstructure that is solid or substantially solid. This, in effect, provides the bacon packaging sheet 20 a skin (the outer regions 44 in FIGS. 2, and 45 in FIG. 3) that is integral to the dosed cell regions of the polymer's microstructure and impervious to wicking. In this and certain other embodiments, the sheet 20 includes a skin that is integral to the plurality of closed cells and whose thickness ranges from 1-100 μm. With the skin, the bacon packaging sheet 20 may better resist tension and/or shear exerted on the sheet 20, and may also be stiffer, or have a greater resistance to bending, than a sheet 20 having the same thickness but closed cells distributed throughout the outer regions 44. To increase the bacon packaging sheet's stiffness without increasing the amount of polymer contained in the bacon packaging sheet 20, one can increase the thickness dimension of the sheet 20 by increasing the size of the closed cells 22 (also discussed in greater detail in conjunction with FIG. 6).

Other embodiments of the bacon packaging sheet 20 are possible. For example, the thermoplastic may include polystyrene, polycarbonate, acrylonitrile-butadiene-styrene, glycol modified PET, polyethylene, polypropylene, NORYL (a blend of polyphenylene oxide and polystyrene), and polyvinyl chloride. In addition, the microstructure may include closed cells 22 in the middle region 42 having a size that ranges between 1 and 30 μm long, and closed cells 22 in the outer regions 44 having a size that ranges between 30 and 60 μm long. In another example, the sheet 20 may include a skin that is not integral. In yet another example, the sheet 20 may not include a skin.

FIG. 6 is a schematic view of a process for generating a closed-cell microstructure in a polymer 50 such as that shown in FIGS. 2-5, according to an embodiment of the invention. The process includes dissolving into the polymer 50 (here shown as a film rolled around a drum 52, but may be a block or thin sheet) a gas 54 that does not react with the polymer 50. The process also includes making the polymer 50 with the dissolved gas thermodynamically unstable at a temperature that is or close to the polymer and dissolved gas combination's glass transition temperature—the temperature at which the polymer 50 is easily malleable but has not yet melted. With the temperature at or near the glass transition temperature, bubbles (not shown) of the gas 54 can nucleate and grow in regions of the polymer 50 that are thermodynamically unstable—i.e. supersaturated. When the bubbles have grown to a desired size, the temperature of the polymer 50 is reduced below the glass transition temperature to stop the bubbles' growth, and thus provide the polymer with a microstructure having closed-cells whose size may range between 1 and 200 μm long.

In the process, the first step 56 is to dissolve into the polymer 50 any desired gas 54 that does not react with the polymer 50. For example, in this and certain other embodiments of the process, the gas 54 may be carbon dioxide (CO₂) because CO₂ is abundant, inexpensive, and does not react with PET. In other embodiments of the process, the gas may be nitrogen and/or helium. Dissolving the gas 54 into the polymer 50 may be accomplished by exposing the polymer for a period of time to an atmosphere of the gas 54 having a temperature and a pressure. The temperature, pressure, and period of time may be any desired temperature, pressure, and period of time to dissolve the desired amount of gas 54 into the polymer 50. The amount of gas 54 dissolved into the polymer 50 is directly proportional to the pressure of the gas 54 and the period of time that the polymer 50 is exposed to the gas 54 at a specific temperature and specific pressure, but is inversely proportional to the temperature of gas 54. For example, in this and certain other embodiments, the temperature may be 72° Fahrenheit, the pressure may be 725 pounds per square inch (psi), and the duration of the period may be 10 hours. This typically saturates the polymer 50 with the gas 54. In other embodiments, the pressure may range between 500 psi and 1000 psi, and the duration of the period may range between 4 hours and 24 hours.

Because the layers of the rolled polymer film 50 that lie between adjacent layers or between a layer and the drum 52 are substantially unexposed to the atmosphere when the roll is placed in the atmosphere, a material 58 is interleaved between each layer of the rolled polymer film that exposes each layer to the atmosphere. In this and certain other embodiments, the material 58 includes a sheet of cellulose, and is disposed between each layer of the polymer film 50 by merging the sheet with the film and then rolling the combination into a single roll 60. The material 58 exposes each layer of the polymer film 50 by allowing the gas to easily pass through it. After the gas 54 has saturated the polymer film 50, the material 58 may be removed from the roll 60 and saved as a roll 62 for re-use.

The next step 64 in the process includes exposing the polymer film 50 with the dissolved gas 54 to an atmosphere having less pressure than the one in the first step to cause the combination of the polymer film 50 and the gas 54 dissolved in the polymer film 50 to become thermodynamically unstable—i.e. the whole polymer or regions of the polymer to become supersaturated with the dissolved gas 54. For example, in this and certain other embodiments, the reduction in pressure may be accomplished by simply exposing the polymer film 50 to atmospheric pressure, which is about 14.7 psi, in the ambient environment.

When the combination of the polymer film 50 and the dissolved gas 54 becomes thermodynamically unstable, the dissolved gas tries to migrate out of the film 50 and into the ambient environment surrounding the film 50. Because the dissolved gas in the interior regions of the polymer film 50, such as the middle region 42 in FIG. 2, must migrate through the regions of the polymer film 50 that are closer to the film's surface, such as the outer regions 44 in FIG. 2, to escape from the polymer film 50, the dissolved gas in the interior regions begins to migrate after the dissolved gas in the surface regions begins to migrate, and takes more time to reach the ambient environment surrounding the polymer film 50 than the dissolved gas 54 in the film's regions that is closer to the film's surface. Thus, before heating the polymer film 50 to a temperature that is or is close to its glass transition temperature, one can modify the concentration of dissolved gas 54 in regions of the polymer film 50 by exposing the polymer film 50 to an atmosphere having less pressure than the one in the first step for a period of time. Because the concentration of dissolved gas 54 depends on the amount of gas that escapes into the ambient environment surrounding the polymer film 50, the concentration of dissolved gas 54 is inversely proportional to the period of time that the film 50 is exposed to the low-pressure atmosphere before being heated to its or close to its glass transition temperature.

In this manner, a skin, such as the skin 45 in FIG. 3, may be formed in the polymer film 50 when the film 50 is heated to a temperature that is or is close to its glass transition temperature. For example, in this and certain other embodiments, the roll 60 of polymer film and interleaved material 58 can remain in a thermodynamically unstable state for a period of time before removing the material 58 from the roll 60 and heating the film. This allows some of the gas dissolved in the region of the film adjacent the film's surface, such as the outer regions 44 in FIG. 2, to escape. With the gas absent from this region of the film, this region becomes more thermodynamically stable than the regions that are further away from the film's surface, such as the middle region 42 in FIG. 2. With a sufficient amount of thermodynamic stability in the region, bubbles won't nucleate in the region when the film is heated close to its glass transition temperature. Consequently, as discussed in conjunction with FIG. 2, closed cells can be omitted from this region of the film, leaving a solid portion of the microstructure that is integral to the closed cell portion of the microstructure, such as the skin 45 in FIG. 3. Because the thickness of the skin or solid portion depends on the absence of dissolved gas in the region of the film, the thickness of the skin or solid portion is directly proportional to the period of time that the film spends in a thermodynamically unstable state before being heated to or substantially close to its glass transition temperature.

The next step 66 in the process is to nucleate and grow bubbles in the polymer 50 to achieve a desired relative density for the polymer film 50. Bubble nucleation and growth begin about when the temperature of the polymer film 50 is or is close to the glass transition temperature of the polymer film 50 with the dissolved gas 54. The duration and temperature at which bubbles are nucleated and grown in the polymer 50 may be any desired duration and temperature that provides the desired relative density. For example, in this and certain other embodiments, the temperature that the PET polymer is heated to is approximately 200°-280° Fahrenheit, which is about 40°-120° warmer than the glass transition temperature of the polymer without any dissolved gas 54. The PET film 50 is held at approximately 200°-280° Fahrenheit for approximately 30 seconds. This provides a relative density of the closed-cell film of about 18.5%, and when the thickness of the PET film before gas dissolution is approximately 0.014 inches then the thickness of the PET film after this heating step 66 (and a subsequent temperature reduction step discussed below) will be approximately 0.019 to 0.022 inches. If the PET film is held at 200°-280° Fahrenheit for a period longer than 30 seconds, such as 120 seconds, then the bubbles grow larger, and thus the size of resulting closed cells are larger. This may provide a relative density of the closed cell film of about 10%-20%, and when the thickness of the PET film before gas saturation is approximately 0.014 inches then the thickness of the PET film after this heating step 66 (and subsequent quenching step discussed below) may be approximately 0.025-0.028 inches If the PET film is held at 200°-280° Fahrenheit for a. period shorter than 30 seconds, such as 10 seconds, then the bubbles remain small, and thus the size of resulting closed cells are smaller. This may provide a relative density of the closed cell film of about 40%, and when the thickness of the PET film before gas saturation is approximately 0.014 inches then the thickness of the PET film after this heating step 66 (and subsequent quenching step discussed below) may be approximately 0.016 inches.

To heat the polymer film 50 that includes the dissolved gas 54, one may use any desired heating apparatus. For example, in this and certain other embodiments, the PET film may be heated by a roll fed flotation/impingement oven, disclosed in the currently pending U.S. patent application Ser. No. 12/423,790, titled ROLL FED FLOTATION/IMPINGEMENT AIR OVENS AND RELATED THERMOFORMING SYSTEMS FOR CORRUGATION-FREE HEATING AND EXPANDING OF GAS IMPREGNATED THERMOPLASTIC WEBS, filed 14 Apr. 2009, and incorporated herein by this reference. This oven suspends and heats a polymer film that moves through the oven, without restricting the expansion of the film.

The next step 68 in the process includes reducing the temperature of the heated polymer, and thus the malleability of the polymer 50 that occurs at or near the glass transition temperature, to stop the growth of the bubbles. The temperature of the heated polymer may be reduced using any desired technique. For example, in this and certain other embodiments, the polymer film 50 may be left to cool at ambient room temperature—i.e. simply removed from the heating apparatus. In other embodiments the heated polymer film 50 may be quenched by drenching it with cold water, cold air, or any other desired medium.

Other embodiments of the process are possible. For example, the polymer film 50 can be heated to a temperature that is or close to its glass transition temperature when the polymer film 50 is initially exposed to an atmosphere that causes the gas dissolved in the polymer film 50 to become thermodynamically unstable. This allows one to make a film that does not include a skin or includes a skin having a minimal thickness.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A packaging material that can be used for packaging bacon and other meats, the packaging material comprising:
a polymer having a microstructure that includes a plurality of closed cells, each cell containing a void and each cell having a maximum dimension extending across the void within the cell that ranges between 1 micrometer and 200 micrometers long.

2. The packaging material of claim 1 wherein the polymer's microstructure is substantially uniform throughout the polymer.

3. The packaging material of claim 1 wherein the maximum dimension extending across the void within each closed cell ranges between 1 micrometers and 60 micrometers.

4. The packaging material of claim 1 wherein the polymer's microstructure has a relative density that ranges between 10% and 40%, wherein the relative density is the density of the polymer having the microstructure that includes the plurality of closed cells, divided by, the density of the polymer having a microstructure that does not include the closed cells.

5. The packaging material of claim 1 wherein the polymer's relative density is 18.5%.

6. The packaging material of claim 1 wherein the polymer includes a thermoplastic.

7. The packaging material of claim 1 wherein the polymer includes polyethylene terephthalate (PET).

8. A bacon packaging sheet that can also be used for packaging other meats, the bacon packaging sheet comprising:
a main portion;
a flap pivotable relative to the main portion;
a first surface that extends across the main portion and the flap, and that contacts bacon and/or other meats when the sheet is used to package the bacon and/or other meats;
a second surface that extends across the main portion and the flap, and that does not contact the bacon and/or other meats when the sheet is used to package the bacon and/or other meats;
a thickness that extends from the first surface to the second surface in a direction perpendicular to the first surface; and
a polymer having a microstructure that includes a plurality of closed cells, each cell containing a void and each cell having a maximum dimension extending across the void within the cell that ranges between 1 micrometers and 200 micrometers long.

9. The bacon packaging sheet of claim 8 wherein the polymer's microstructure extends across the sheet's thickness.

10. The bacon packaging sheet of claim 8 wherein the thickness has a region that includes at least one of the first and second surfaces and that does not include a cell.

11. The bacon packaging sheet of claim 8 wherein the thickness ranges between 0.014 inches and 0.028 inches.

12. The bacon packaging sheet of claim 8 wherein the thickness is 0.022 inches.

13. The bacon packaging sheet of claim 8 wherein the polymer includes polyethylene terephthalate (PET).

14. The bacon packaging sheet of claim 8 wherein:
the main portion is substantially rectangular and 5.5 inches by 10.1 inches, and includes a window through which a consumer can view the bacon and/or other meats when the bacon and/or other meats contact the first surface, and
the flap is substantially trapezoidal and 2.4 inches by 9.6 inches by 7.5 inches.

15. The bacon packaging sheet of claim 8 wherein the second surface includes at least one of the following, text and graphics, to convey information to a consumer.

16. A method for making a bacon packaging sheet that can also be used for packaging other meats, the method comprising:
forming a polymer into a bacon packaging sheet having:
a main portion,
a flap pivotable relative to the main portion,
a first surface that extends across the main portion and the flap, and that contacts bacon and/or other meats when the sheet is used to package the bacon and/or other meats,
a second surface that extends across the main portion and the flap, and that does not contact the bacon and/or other meats when the sheet is used to package the bacon and/or other meats, and
a thickness that extends from the first surface to the second surface in a direction perpendicular to the first surface,
the polymer having a microstructure that includes a plurality of closed cells, each closed cell containing a void and each closed cell having a maximum dimension extending across the void within the closed cell that ranges between 1 micrometer and 200 micrometers long.

17. The method of claim 16 wherein forming the polymer into a sheet includes cutting the polymer to generate the main portion.

18. The method of claim 16 wherein forming the polymer into a sheet includes bending the polymer to generate the flap.

19. The method of claim 16 further comprising generating the microstructure of the polymer by:
exposing layers of a roll of a polymer film to an atmosphere of a gas pressurized to saturate the polymer film with the gas, the roll of the polymer film including a material disposed between the layers of the rolled polymer film to expose to the atmosphere the region of the polymer layers that the material lies between;
initiating cell nucleation by:
reducing the pressure of the gas atmosphere to cause the exposed layers of the polymer film to become supersaturated, and
heating the exposed layers of the polymer film to at least a glass transition temperature of the polymer material;
holding the temperature of the exposed layers for a period of time to grow the size of cells; and
reducing the temperature of the exposed layers to stop the growth in size of the cells.

20. The method of claim 19 wherein:
the polymer film includes polyethylene terephthalate (PET) having a thickness of 0.014 inches,
the layers of the rolled polymer film are exposed for a period between 4 hours and 24 hours to carbon dioxide at a temperature of 72° Fahrenheit and at a pressure between 500 psi and 1,000 psi, and
the glass transition temperature is 165.2° Fahrenheit.

21. A method for packaging bacon and other meats, the method comprising:
placing bacon and/or other meats on a first surface of a bacon packaging sheet, wherein the bacon packaging sheet includes polymer having a microstructure that includes a plurality of closed cells, each closed cell containing a void and each closed cell having a maximum dimension extending across the void within the closed cell that ranges between 1 micrometer and 200 micrometers long; and
folding a flap of the sheet around an edge of the bacon and/or other meats.

22. The method of claim 21 further comprising:
wrapping a plastic film around the bacon and bacon packaging sheet, and
sealing the plastic film to isolate the bacon and bacon packaging sheet from the environment outside.
